(19) United States
(12) Patent Application Publication
(10) Pub. No.: US 2006/0260495 A1
(43) Pub. Date: Nov. 23, 2006

(54) De-stacking device and magazining device

(76) Inventor: Udo Siedlaczek, Straelen (DE)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 10/547,892

(22) PCT Filed: Mar. 4, 2004
(86) PCT No.: PCT/EP04/02189

§ 371 Date: Jul. 10, 2006

(30) Foreign Application Priority Data
Mar. 4, 2003 (DE) 103 09 553.5
Jun. 12, 2003 (DE) 103 26 993.2
Jun. 26, 2003 (DE) 103 28 973.9

(51) Int. Cl. G03G 15/32

(52) U.S. Cl. 101/494

(57) ABSTRACT

A de-stacking device (1) for at least partially de-stacking a stack (2) of containers (3) which are stacked inside each other, preferably stacked plant pots, comprising an upper holding arm (4) used to hold the stack (2), at least one lower holding arm (5) which is at least used to hold the container (8) that is to be marked, and preferably comprising at least one separating arm (6) which is located between the upper and lower holding arms (4,5) and which is used to separate a container (8) which is to be marked from the stack (2). According to the invention, a marker device (7) which is connected to the de-stacking device (1) is provided in order to mark an at least partially de-stacked container (8) and the marker device (7) is directly connected to the de-stacking device (1), forming a common unit, in order to further develop said de-stacking device (1).

The invention concerns a de-stacking device according to the preamble of claim 1. Furthermore, the invention concerns a potting machine with a de-stacking device of the aforesaid kind. Moreover, the invention concerns a magazining device according to the preamble of claim 15.

For the potting of plants at nurseries, one makes use of pots that are labeled or otherwise imprinted and contain information on the plants in the pots. For this purpose, it is customary to provide the pots already appropriately labeled to the nurseries. These pots are then fed as a stack to a potting machine, and it is first necessary to remove the pots from the stack. After the unstacking or singling out of the individual flower pots, they are filled with soil and the particular plants on a conveyor device of the potting machine. The drawback to this known method is that a separate step of marking or labeling of the flower pots must precede the potting, which is generally done by a specialized firm. During the potting process, one must always make sure the proper plants are put into the pots which are labeled in a particular way.

The problem of the present invention is to create a remedy for this.

This problem is solved according to the invention by the features of claim 1 for a de-stacking device of the kind described above. The invention is distinguished from the prior art in that the de-stacking device is designed not only to de-stack the containers being marked, but also to mark the container directly and at the same time. The de-stacking device and the marking device constitute a common subassembly, with which both the de-stacking step and the marking step can be carried out. The combining of the functions of “de-stacking” and “marking” into one subassembly means in fact that the work space required to perform the particular step can be reduced significantly as compared to those layouts in which the de-stacking step and the marking step take place in subassemblies which are independent and separate from each other. According to the invention, the de-stacking device is thus given an additional function, wherein the work space normally required for the de-stacking and the marking can be significantly reduced by the invention. Since the de-stacking device contains both the means necessary for the de-stacking and the means necessary for the marking of the container, it is possible in simple fashion to kinematically couple the de-stacking step to the marking step or to attune both work processes to each other. By “kinematic coupling” it is meant here that the relevant parts of the marking device and the de-stacking device at least move jointly, due to the direct connection of the two devices. Since normally one de-stacking device for de-stacking the containers and one marking device for marking the containers are provided as subassemblies which are spatially separated from each other, it is fundamentally difficult on account of space considerations to arrange a marking device at a sufficiently short distance from the stack of containers to ensure an exact affixing of the marking. Thanks to the invention's coupling of the de-stacking device to the marking device, the latter can be arranged sufficiently close to the stack of containers to ensure an exact placement of the marking on the container. Thanks to the de-stacking device of the invention, the spatially connected arrangement of the means of de-stacking and the means of marking the containers furthermore makes it possible to accomplish an extraordinarily rapid marking. The marking step for each individual container does not constitute a limitation on the de-stacking process. With the invention, the de-stacking with combined marking of the containers can take place just as fast as in the prior art, where merely de-stacking is done.

Moreover, it should be pointed out that both conical circle-shaped containers and also containers with corners can be de-stacked and marked. The area of application, for example, encompasses the labeling or imprinting of flower pots or even yogurt cups.

In order to further reduce the work space required for the de-stacking and the marking of the containers, in a preferred embodiment of the invention the marking device and the upper and/or the lower holding arm and/or the separating arm are arranged in a common plane, especially a vertical plane, and the center longitudinal axis of the stack in the area of the de-stacking device runs essentially in the plane and/or parallel to it. In this regard, it is pointed out that the marking device and the means for de-stacking the container, namely, the upper and the lower holding arm and also if necessary the separating arm can be arranged, if possible, so as to produce a compact construction of the de-stacking device and substantially reduce the necessary work space for the de-stacking and marking of the containers, that is, the distance from the marking device to the stack.

Moreover, it is to be noted that the invented configuration can be realized not only for new layouts, but also existing devices can easily be retrofitted.

Preferably, the containers are marked with labels, wherein the marking device can have a labeling device which can be configured as a pneumatic blowing or suction type device for affixing a label to the container. The labeling device is preferably joined to the upper holding arm and/or to the lower holding arm and/or to the separating arm, in particular, it is arranged beneath the lower holding arm and joined to it. The important point is that the direct coordinating or fastening of the labeling device to the particular arm cannot cause any mutual hindrance for the means of de-stacking the container and means of marking the container. Finally, it is important that, despite the coupling of the labeling device with the respective arm, there is easy access to the means for de-stacking the container and to the labeling device, so as to perform maintenance and repairs.

Instead of the labeling device, which shall be further discussed afterwards, the de-stacking device can also have a spraying device for spraying on a marking. The following configurations apply essentially to the labeling device, but they should be understood equally in relation to the spraying device, without this needing to be mentioned in particular.

The labeling device and/or the holding arms and/or the separating arm, thanks to the firm connection, can move jointly relative to the stack or to the container being labeled. The unstacking process takes place in the usual way and in familiar fashion from the prior art, and because of the mechanical coupling between the movement of the labeling device and the movement of at least one of the two holding arms and/or the separating arm there is a kinematic coupling which allows a frictionless course of the unstacking process and the marking of the containers.

The labeling device, for example, can be configured so that it can move in lateral direction up to the container being marked along a travel path between a return position away from the container and an affixing position facing the container. In the affixing position, the labeling device is preferably situated at the front end of the travel path facing the container, while in the return position the labeling device can be situated at the rear end of the travel path away from the container. The front end, that is, the clearance between the labeling device and the container being labeled, is preferably less than 10 cm. It is especially favorable to make this distance between 1 and 5 cm, any intermediate value being possible without needing to be mentioned in particular. Thus, the labeling device can be moved or travel back and forth with the respective arm from the return position to the affixing position. The lower holding arm and/or the upper holding arm and/or the separating arm can likewise be configured so as to move along a travel path, possibly of different length, relative to the stack or to the container being labeled, in a way familiar from the prior art.

For space considerations, it is especially favorable for the lower holding arm to be coupled to the labeling device so as to move in the direction of the container being labeled, so that in an end position of the lower holding arm, namely, when the lower holding arm detains the container being labeled from moving further in the unstacking direction, the labeling device is situated in the affixing position at the front end of its travel, facing the container, and thus the label can be affixed to the container in the shortest possible distance. In the affixing position, the distance between the label being affixed to the container and the container being labeled can be only a few centimeters—as already mentioned. This ensures, in particular, that the label can be exactly positioned on the container in an easy manner. As an alternative to this, the labeling device can also be connected to the upper holding arm or also to the separating arm, but the arrangement of the labeling device must make sure that the label can be applied trouble-free and with high precision to the container being labeled.

For the loading of the labeling device, the marking device can have a label dispenser. Basically, it is also possible for the marking of the container to be applied by spraying on information, in which case the marking device can have a spraying device and a reservoir of ink to supply the spraying device. Preferably, the invention calls for the labeling device being able to move relative to the label dispenser, or the spraying device being able to do so relative to the ink reservoir.

While the labeling device or spraying device can be arranged to be movable along with the upper or the lower holding arm and/or with the separating arm, in a preferred embodiment of the invention the label dispenser or the ink reservoir is fixed in relation to the de-stacking device or the stack. This has the advantage that the label dispenser or the ink reservoir is arranged outside the path of moving parts and thus there is no danger to people when gaining access to the label dispenser or the ink reservoir. Furthermore, an access is also easily possible during the unstacking and the marking of the containers. Moreover, the fixed arrangement of the label dispenser or ink reservoir ensures that the feeding of labels or the ink supply is not hindered by the continual back and forth movement of the arm during the unstacking.

In order to guarantee an easy access to the label dispenser or ink reservoir, the label dispenser or ink reservoir can be arranged in the area of the end of the travel path of the labeling device away from the container. If there is a chance of fouling of the means provided for unstacking of the containers and of the marking device by a filling of the containers after the labeling process, the separating of the labeling device from the label dispenser and the arranging of the label dispenser in the area of the end of the travel path of the labeling device away from the container will ensure the least possible damage to the label dispenser and minimize the number of labels that are unsuitable for affixing to a container as a result of fouling.

In the return position of the labeling device, the front end of the labeling device used to affix the label and a feeding opening of the label dispenser are at least basically aligned. This simplifies the feeding of unused labels in the direction of the labeling device and their placement in a position in the labeling device designed for being affixed to the container, which helps increase the speed of the labeling and prevents disruptions from jammed labels in the feeding process.

Although the labeling device is preferably moved between the return position and the affixing position along a straight path, movement of the labeling device or the spraying device around the container being marked, or rotation of the container being marked, or preferably the entire stack, around the marking device is also fundamentally possible.

The problem stated at the outset is solved according to the invention in a magazining device of the above mentioned kind in that a marking device is provided for the marking of an at least partly unstacked container and the marking device is connected to the guiding mechanism. Thanks to the magazining device of the invention, it is possible to carry out the marking step for the container being marked immediately before the filling or processing of the container, so that the marking step can occur close in time to the subsequent filling or further processing of the marked container. Furthermore, the marking device is connected to the guiding mechanism, i.e., it is situated at very close distance to the container being marked or to the stack. This ensures a precise marking of the containers, even when the marking speed is high.

The magazining device itself is provided for picking up and handing off a stack of containers to be filled or processed to a filling or processing device, wherein the magazining device ensures a continuous supplying of the filling or processing device with labeled containers. The magazining device is preferably connected to the filling or processing device and/or situated in immediate proximity to the filling or processing device. The magazining device has a guiding mechanism for picking up and handing off a stack, and in the most simple instance the stack being handed off to the filling or processing device for filling or processing is guided between two guiding segments of the guiding mechanism.

During the filling or processing step, the stack of containers being filled or processed is moved further in the direction of the filling location or the processing location, wherein the guiding mechanism of the magazining device ensures that the stack always has the intended direction of movement or the intended position relative to the filling or processing device.

The filling or processing device can be, for example, a potting machine for flower pots that are being filled. Preferably the magazining device is connected firmly to the filling or processing device and/or is an integral part of the filling or processing device. But it is also basically possible for the magazining device to not be firmly connected to the filling or processing device and to only be situated in immediate proximity to the filling or processing device, in which case one must constantly ensure that the stack of containers being filled or processed is handed off to the filling or processing location.

In order to make possible the closest possible spacing of the marking device with respect to the container being marked and to greatly minimize the space required for the marking process, the marking device is fastened directly to the first guiding segment and/or to the second guiding segment. Preferably, the free space present between the magazining device or the guiding mechanism and the filling or processing device is utilized as optimally as possible.

In order to ensure easy access to the marking device and the supplying of the marking device with a marking means for marking the containers in simple manner, according to the invention the marking device is joined removably or permanently to the guiding mechanism from the outside. For example, the marking device on the outside of the first guiding segment and/or the second guiding segment can be screwed to the first guiding segment and/or the second guiding segment.

The guiding mechanism is preferably configured in the form of a shaft, the term “form of a shaft” meaning cross sectional shapes which allow for the receiving and further transport of a stack of containers to be filled or processed. Preferably, the guiding mechanism has a plurality of guiding segments, which are arranged relative to each other so as to produce an n-cornered shaft to accommodate the stack. However, it is also possible for the guiding mechanism to have a tubular cross section, whose inner diameter corresponds at least to the outer diameter of the containers. The first guiding segment and the second guiding segment can be shaped as shells. Preferably the guiding segments are arranged relative to each other so as to enable an unstacking of the containers being marked, preferably with a de-stacking device of the above-described kind.

One preferred embodiment of the invention calls for the marking of the containers to occur from the outside, in which case the marking device, as already explained above, can be fastened to the guiding mechanism from the outside. The first guiding segment and/or the second guiding segment can have at least one recess in the area of the at least partly unstacked container, in order to assure the affixing of a marking means, such as a label, onto the container being marked by the guiding segments from the outside. However, it is also basically possible for the guiding segments to be spaced apart by a distance which enables a marking of the at least partly unstacked container.

The marking device can have a labeling device and/or a spraying device, and it is basically sufficient for a precise marking of the container that the labeling device and/or the spraying device be arranged at a very slight distance from the container being marked, for example, at a distance of <20 cm, preferably <10 cm, especially at a distance of several centimeters.

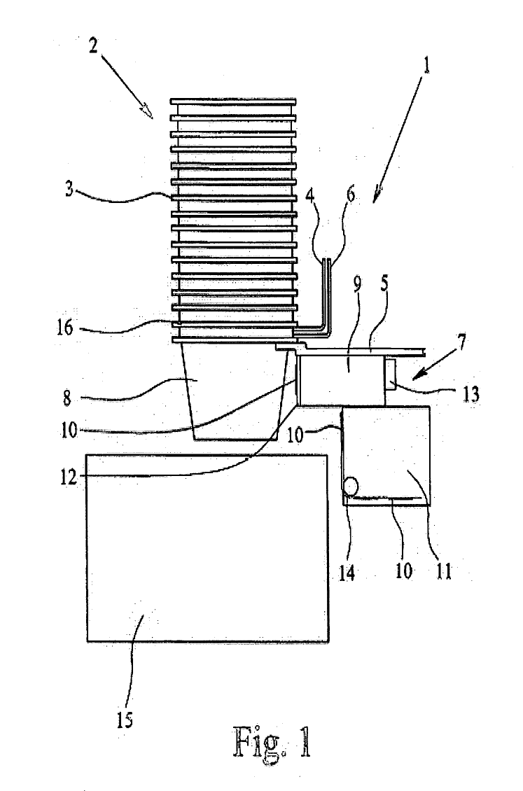

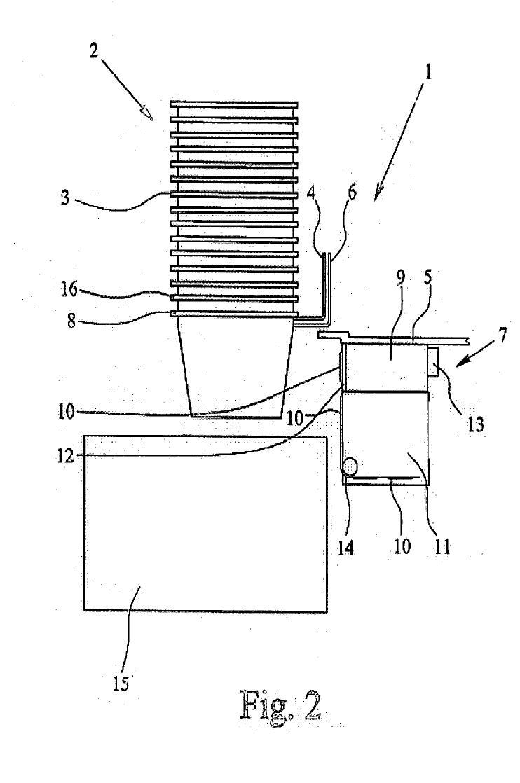

Moreover, the invention allows one to combine the features described by the invention in relation to the de-stacking device with a magazining device of the kind in the invention, if desired. This holds in particular for the configuration of the labeling device and the labeling process described hereafter by means of FIGS. 1 and 2, as well as for the unstacking process.

The invention will be described more closely hereafter by means of the drawing, without limiting the general notion of the invention. This shows:

FIG. 1, one embodiment of the invented de-stacking device with a marking device having a labeling device, wherein the labeling device is situated at the end of a travel path of the labeling device facing the container,

FIG. 2, the de-stacking device shown in FIG. 1 with the labeling device in a return position, wherein the labeling device is situated at the end of the travel path of the labeling device facing away from the container, and

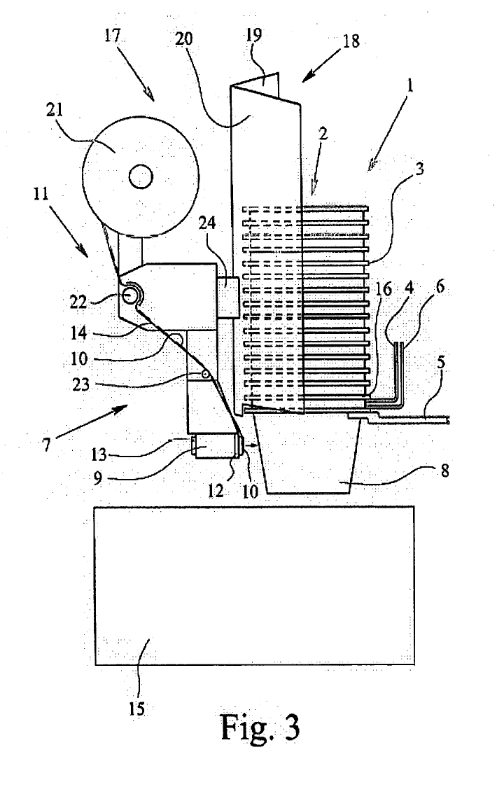

FIG. 3, one embodiment of the magazining device of the invention.

FIG. 1 shows a de-stacking device 1 for the at least partial unstacking of an essentially vertically arranged stack 2 of containers 3 which are stacked together. The de-stacking device 1 has an upper holding arm 4, a lower holding arm 5, and a separating arm 6 provided between the two holding arms 4, 5 for separating the container 3 being marked from the stack 2. Furthermore, the de-stacking device 1 has a marking device 7. The marking device 7 is provided for the marking of an at least partially unstacked container 8, wherein a labeling device 9 affixes a label 10, taken up by suction, onto the unstacked container 8 being labeled, by a puff of air. The container 8 being marked each time is generally the last container in the stack 2. The marking device 7, moreover, has a label dispenser 11, which serves to load or supply the labeling device 9 with labels 10.

The labeling device 9 can be, per FIGS. 1 and 2, a vacuum and vent box, which can be adjusted in its size depending on the pot size and the label format. The labeling device 9 and the label dispenser 11 are preferably devices whose function is known from the prior art. The labeling device 9 holds a label 10 in readiness by a vacuum which is generated on a suction plate 12, permeable to air, which faces the container 8 being removed from the stack. To produce the vacuum, the labeling device 9 has a fan 13 or similar blower, which also serves to produce a puff of air, which pushes the label 10 from the suction plate 12 onto the container 8 being removed from the stack. In this case, the fan 13 is selectively operated in suction mode to produce the vacuum and in blowing mode to produce puffs of air. It is also possible to use a compressor to generate a puff of air. In this case, the fan 13 can remain constantly in suction mode, while the compressor is operated periodically to produce puffs of air. The label dispenser 11 has a ribbonlike carrier 14 with unused labels 10, which is advanced in the direction of the labeling device 9 for the labeling of the containers 3.

In the position represented in FIG. 1, the labeling device 9 is in the affixing position, wherein the labeling device 9 is situated in the area of a front end of a travel path of the labeling device 9 turned toward the container 8 being de-stacked. The labeling device 9 can, as in FIG. 1, be able to move along with the lower holding arm 5, and preferably the labeling device 9 is joined to the lower holding arm 5 underneath it. However, it is just as possible for the labeling device 9 to be joined to the upper holding arm 4 or the separating arm 6—given an appropriate configuration of the upper holding arm 4 or the separating arm 6—and to be able to move along with these.

Now, in the embodiments represented in FIGS. 1 and 2, the marking device 7 and the means for de-stacking the containers 3 of the stack 2, namely, the upper holding arm 4, the separating arm 6, and the lower holding arm 5, are arranged in a common plane. This produces an especially space-saving layout of the de-stacking device 1. The stack 2 can preferably be de-stacked in the vertical direction, in which case the stack 2 can be arranged basically vertical. However, the stack can basically be arranged at any angle between 60° and 90° to the horizontal. Moreover, however, it is also possible for the stack 2 to be de-stacked in the horizontal direction. The de-stacking device shown in FIGS. 1 and 2 can be used in a potting machine 15, and the potting machine 15 can be designed, for example, for the filling of flower pots.

The de-stacking process and the marking of the container 3 shall now be described by means of FIGS. 1 and 2. In FIG. 1, the holder 16 of the stack 2 that follows the container 8 being de-stacked is held by the upper holding arm 4. The container 8 being de-stacked and labeled is held by the lower holding arm 5. The labeling device 9 is located in the affixing position, and the label 10 in the condition as shown by FIG. 1 is held firmly against the air-permeable suction plate 12 by the vacuum generated by the labeling device 9. After the label 10 is blown from the air-permeable suction plate 12 toward the container 8 or after the labeling of the container 8, the labeling device 9 together with the lower holding arm 5 is moved away from the stack 2, whereupon the labeled container 8 is detached from the stack 2 by the separating arm 6 and drops into the potting machine 15 for further processing.

FIG. 2 shows the de-stacking device 1 with the labeling device 9 being shown in the return position at the back end of the travel path of the labeling device 9, facing away from the stack 2. The labeling device 9 can move relative to the label dispenser 11. Basically, of course, it is also possible for the label dispenser 11 and the labeling device 9 to be formed as a single piece or to move together. But according to the embodiment shown in FIGS. 1 and 2, the label dispenser 11 is connected stationary to the de-stacking device 1.

In the return position of the labeling device 9, the suction plate 12 of the labeling device 9, provided for affixing the label 10, is flush with the label dispenser 11, so that the feeding of unused labels 10 is assured. In the return position, the labeling device 9 is filled with a new label 10 and then moves again toward the stack 2 into the affixing position, together with the lower holding arm 5. The loading of a label 10 into the labeling device 9 by the label dispenser 111 can also occur pneumatically.

After reaching the affixing position, the lower holding arm 5, shaped as a circular arc at its free end, grabs the edge of the last container 8 being labeled. At the same time, the upper holding arm 4 and the separating arm 6 are retracted so as to then grab the edge of the next container 16. At the same time, the label 10 can be affixed to the last container 8.

Moreover, it should be noted that the marking device 7 can also be a spraying device. Finally, it is also possible for the labeling device 9 or the spraying device to move around a container 3 for the marking thereof, or for the container 3 being marked, and preferably the entire stack 2, to perform a rotary movement.

FIG. 3 shows a de-stacking device 1 for the at least partial de-stacking of an essentially vertically positioned stack 2 of containers 3 nested in each other. The de-stacking device 1 shown in FIG. 3 can essentially correspond to the de-stacking device 1 shown in FIGS. 1 and 2, with the exception that the de-stacking device 1 shown in FIG. 3 does not have a labeling device, although this is also very possible.

Moreover, FIG. 3 shows a magazining device 17 for receiving and handing off a stack 2 of containers 3 being marked, where the magazining device 17 has a guiding mechanism 18. The stack 2, according to FIG. 3, is guided between a first guiding segment 19 and a second guiding segment 20 of the guiding mechanism 18.

In order to be able to perform the marking of the containers 3 in a simple manner and with high precision in immediate physical and temporal proximity to the de-stacking process for the containers 3, according to the invention the magazining device 17 has a marking device 7 for marking the at least partly de-stacked containers 8, and the marking device 7 itself is firmly connected to the guiding mechanism 18 per FIG. 3. For example, the marking device 7 can be screwed together with the guiding mechanism 18.

The marking device 7 per FIG. 3 has a labeling device 9 for affixing a label 10 to the partly de-stacked containers 8. The labeling device 9 can basically correspond to the labeling device 9 depicted in FIGS. 1 and 2. Furthermore, the marking device 7 has a label dispenser 11. In the embodiment of the invented magazining device represented in FIG. 3, the labels 10 are transported from a substrate 14 wound on a roll 21 across deflection rollers 22, 23 to the suction plate 12 of the labeling device 9, and the label 10 is pushed away from the suction plate 12 by a puff of air and can be affixed to the container 8 being de-stacked. In this case, a fan 13 is provided, which can selectively work in suction mode to produce a vacuum or in blowing mode to produce puffs of air. In other respects, the process of affixing the labels 10 to the partly de-stacked containers 8 can take place in the manner described in connection with FIGS. 1 and 2.

Furthermore, in the embodiment represented in FIG. 3, the marking device 7 is connected from the outside to the guiding mechanism 18. A preferred embodiment calls for the marking device 7 being joined to a carrying arm 24 of the guiding mechanism 18, wherein the carrying arm 24 can be used to fasten the magazining device 17 to the potting machine 15. The carrying arm 24 can be firmly connected from the outside, as in the embodiment of FIG. 3, to the first guiding segment 19 and/or to the second guiding segment 20, preferably by welding. However, it is also quite possible to connect the marking device 7 directly to the first guiding segment 19 and/or the second guiding segment 20.

The guiding segments 19, 20 are joined together at an angle, and the stack 2 of containers 3 being marked is moved forward along the guiding mechanism 18 for the filling or further processing of the containers 3 in the direction of the potting machine 15. The de-stacking process of the containers 3 of the stack 2 can correspond to the de-stacking process as described by means of FIGS. 1 and 2. However, it is also quite possible for the stack 2 to be led between the first guiding segment 19 and the second guiding segment 20 or for the guiding mechanism 18 to have guiding segments arranged to form a shaft, in which the stack 2 is moved in the direction of the potting machine 15.

In order to make possible the blowing of the label 10 onto the container 8 being labeled from the suction plate 12, in the magazining device 17 shown in FIG. 3 the labeling device 9 is arranged underneath the guiding segments 19, 20. However, it is equally possible for the first guiding segment 19 and/or the second guiding segment 20 to have at least one recess in the region of the at least partly de-stacked container 8, in order to enable the affixing of the label 10 to the container 8.

Finally, it should be noted that a spraying device for marking the containers 8 can be provided in addition to or in place of a labeling device 9. Moreover, if need by, the invention allows the container 8 to be marked from both sides, in which case the de-stacking device 1 can likewise be configured for the marking of the container 8.

1. De-stacking device with a de-stacking unit (1) for at least partial de-stacking of a stack (2) of containers (3) nested in each other, wherein the de-stacking unit (1) has at least one upper holding arm (4) for holding the stack (2) and at least one lower arm (5) at least for holding one container (8) being marked, characterized in that a marking device (7) is provided for marking an at least partly de-stacked container (8) and in that the marking device (7) is directly connected to the de-stacking unit (1), thereby forming a common subassembly.

2. De-stacking device per claim 1, characterized in that the marking device (7) and at least one of the upper holding arm (4) and the lower holding arm (5) and the separating arm (6) are arranged in a common plane, and the center longitudinal axis of the stack (2) in the area of the de-stacking device (1) runs parallel therewith.

3. De-stacking device per claim 1, characterized in that the marking device (7) has a labeling device (9) which is preferably configured as a pneumatic device for affixing a label (10) to the container (8).

4. De-stacking device per claim 3, characterized in that the labeling device (9) is joined to at least one of the upper holding arm (4), the lower holding arm (5) and the separating arm (6) for separating the container (8) being marked from the stack (2), wherein the labeling device (9) is arranged beneath the lower holding arm (5).

5. De-stacking device per claim 4, characterized in that the labeling device (9) and at least one of the holding arms (4, 5) and the separating arm (6) can move relative to the stack (2) together with the at least one of said holding arms (4, 5) and said separating arm (6).

6. De-stacking device per claim 5, characterized in that the labeling device (9) is arranged next to the container (8) being marked and is constructed and arranged to move along a travel path between a return position away from the container (8) and an affixing position facing the container (8).

7. De-stacking device per claim 6, characterized in that at least one of the upper holding arm (4) and the lower holding arm (5) and the separating arm (6) can move along a travel path relative to the stack (2) and the labeling device (9) is in the affixing position when said at least one of the lower holding arm (5) and the upper holding arm (4) and the separating arm (6) grabs the stack (2).

8. De-stacking device per claim 7, characterized in that the marking device (7) has a label dispenser (11) arranged preferably underneath the labeling device (9).

9. De-stacking device per claim 8, characterized in that the marking device (7) has a spraying device for spraying a marking onto the container (3).

10. De-stacking device per claim 9, characterized in that the marking device (7) has a reservoir for ink for providing ink to the spraying device.

11. De-stacking device per claim 10, characterized in that the labeling device (9) is constructed and arranged to move relative to the label dispenser (11).

12. De-stacking device per claim 11, characterized in that the label dispenser (11) is arranged in the region of the end of the travel path of the labeling device (9) facing away from the container.

13. De-stacking device per claim 12, characterized in that the front side of the labeling device (9) is constructed and arranged to affix the label (10) and a label feed opening of the label dispenser (11) are essentially aligned in the return position of the labeling device (9).

14. De-stacking device per claim 13, characterized in that the labeling device (9) is constructed and arranged to be able to rotate about the container (3) being marked, and preferably the stack (2) is constructed and arranged to rotate relative to the marking device (7).

15. Magazining device with a magazining unit (17) for filling a stack (2) of containers (3) to be marked, wherein the magazining unit (17) has a guiding mechanism (18), and the guiding mechanism (18) has at least one first guiding segment (19) and at least one second guiding segment (20), and wherein the stack (2) is arranged and guided between the first guiding segment (19) and the second guiding segment (20) and is placed on and guided between the first guiding segment (19) and the second guiding segment (20), characterized in that a marking device (7) is provided for the marking of an at least partly de-stacked container (8) and in that the marking device (7) is connected directly to the guiding mechanism (18).

16. Magazining device per claim 15, characterized in that the marking device (7) is connected from the outside to at least one of the first guiding segment (19) and the second guiding segment (20).

17. Magazining device per claim 16, characterized in that the guiding mechanism (18) has guiding segments arranged to form a shaft.

18. Magazining device per claim 17, characterized in that at least one of the first guiding segment (19) and the second guiding segment (20) have at least one recess in the region of the at least partly de-stacked container (8).

19. Magazining device per claim 18, characterized in that the marking device (7) has a labeling device (9) or a spraying device.

20. A potting machine (15) for the filling of flower pots with a de-stacking device according to claim 1.

21. A marking device (7) for use in a magazining device according to claim 15.

22. A potting machine for the filling of flower pots with a magazining device according to claim 15.
